(19) United States
(12) Patent Application Publication
(10) Pub. No.: US 2006/0182182 A1
(43) Pub. Date: Aug. 17, 2006

(54) Image decoding apparatus and memory management unit

(75) Inventors: Koji Nakajima, Kyoto (JP); Eiji Otomura, Osaka (JP); Manabu Kuroda, Hyogo (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/274,300

(22) Filed: Nov. 16, 2005

(30) Foreign Application Priority Data
Feb. 16, 2005 (JP) 2005-039399

(51) Int. Cl. H04N 11/02; H04N 11/04; H04N 7/12; H04B 1/66

(52) U.S. Cl. 375/240.25

(57) ABSTRACT

An image processing system includes a memory management unit and an image decoding apparatus. The memory management unit receives first information regarding control of a frame memory, releases a frame in the frame memory in accordance with the first information, and outputs second information indicating the released frame. The image decoding apparatus decodes encoded image data into an image, and then stores the decoded image in the frame that the second information indicates. The image decoding apparatus then determines, according to the encoded image data, which image among the images stored in the frame memory is not to be referenced in decoding process, and outputs, as the first information, information regarding release of the frame in which that non-referenced image is stored.

### CROSS-REFERENCE TO RELATED APPLICATION

This application claims priority under 35 USC 119 to Japanese Patent Application No. 2005-39399 filed on Feb. 16, 2005, the entire contents of which are incorporated herein by reference.

### BACKGROUND OF THE INVENTION

The present invention relates to image processing systems, and more particularly relates to an image processing system including an image decoding apparatus for decoding images and a memory management unit for controlling a frame memory.

In recent years, moving picture coding techniques have been utilized in various fields such as digital TVs and DVDs (digital versatile discs). For example, in the MPEG (Motion Picture Experts Group) standard, when an encoded picture is decoded, motion compensation is used, in which the current picture is decoded by referring to a previously decoded image or images. The number of past pictures that can be used to decode a single picture (which will be hereinafter referred to as “reference pictures”) varies depending on the moving picture coding method used. For instance, in the MPEG-2 standard, which is employed for DVDs and the like, the maximum number of reference pictures is two. On the other hand, in MPEG-4 SP (MPEG4-Simple Profile), which is used for video phones and the like, the maximum number of reference pictures is one. In MPEG-4 AVC (MPEG4-Advanced Video Coding), which was newly developed in 2003, three or more reference pictures can be used.

In MPEG-2 and MPEG-4 SP, the number of reference pictures to be used and the temporal positions thereof are determined by the type of picture. For example, in MPEG-2, there are three types of pictures: I pictures, P pictures, and B pictures. I pictures do not need any reference pictures. A P picture uses, as a reference picture, the I or P picture that was decoded immediately before that P picture. A B picture uses, as reference pictures, the I or P pictures existing immediately before and after the B picture in time order in which they are actually displayed on the screen. On the other hand, in MPEG-4 AVC, the number of reference pictures and the temporal positions thereof are not determined by the type of picture alone, and therefore information on the number of reference pictures and the temporal positions thereof is contained in encoded image data.

A section for controlling, in image decoding processing, the positions of decoded images stored in the frame memory is called a memory management unit. Since the size of the frame memory is limited, the memory management unit typically controls the frame memory in such a manner that areas in images that are no longer used as reference pictures are reused in later decoding processing.

The process of controlling the storage location of a decoded image in a frame memory has conventionally been performed as follows: an image decoding apparatus notifies a memory management unit of the type of decoded image as information, and the memory management unit controls the storage location of the decoded image in accordance with the information.

The above-mentioned frame memory control method is sufficient for MPEG-2 and MPEG-4 SP. However, in the case of a moving picture coding method, such as MPEG-4 AVC, in which the number of reference pictures and the temporal positions thereof are not determined by the type of picture alone, the storage locations of decoded images cannot be controlled by the above method.

In order to realize memory control that is applicable not only to MPEG-2 and MPEG-4 SP, but also to MPEG-4 AVC, a memory management unit, specially designed for MPEG-4 AVC so as to perform frame memory control based on parameter information regarding the number of reference pictures and the temporal positions thereof that vary for each encoded image data, may be added independently of a memory management unit specifically designed for MPEG-2 and MPEG-4 SP. In such a case, however, problems occur in that increase in the amount of parameter information results in the complicated configuration of the memory management unit and hence in the increased circuit size, and the amount of communication traffic flowing between the image decoding apparatus and the memory management unit in connection with memory control is increased. In addition, since information on memory control varies depending on the type of moving picture coding method, the interface between the image decoding apparatus and the memory management unit needs to be changed for each moving picture coding method.

### SUMMARY OF THE INVENTION

In view of the above problems, it is therefore an objective of the present invention to realize a memory management unit capable of controlling a frame memory in a common way applicable to any type of moving picture coding method, and an image decoding apparatus capable of performing processing that corresponds to the memory management unit.

In order to achieve the object, an inventive memory management unit for controlling a frame memory for storing therein images decoded by an image decoding apparatus includes: a control section for receiving, from outside, first information on release of a frame in which an image that is not to be referenced in image decoding processing performed by the image decoding apparatus is stored, and releasing the frame in accordance with the first information; and a storage location determination section for outputting, to outside, second information indicating the released frame.

An inventive image decoding apparatus includes: an image decoding section for decoding encoded image data into an image and storing the image in a frame indicated from outside; and a determination section for determining, according to the encoded image data, which image, among an image to be stored in the frame and images stored in a frame memory, is not to be referenced in decoding process performed by the image decoding section, and outputting, to outside, first information on release of a frame in which the image that is not to be referenced is stored.

In an inventive image processing system including an image decoding apparatus for decoding encoded image data into an image, and a memory management unit for controlling a frame memory in which the decoded image is stored, the memory management unit includes: a control section for receiving first information on control of the frame memory and releasing a frame in the frame memory in accordance with the first information, and a storage location determination section for outputting second information indicating the released frame; and the image decoding apparatus includes: an image decoding section for decoding the encoded image data into the image and storing the decoded image in the frame that the second information indicates, and a determination section for determining, according to the encoded image data, which image among the images stored in the frame memory is not to be referenced in decoding process performed by the image decoding section, and outputting, as the first information, information on release of a frame in which the image that is not to be referenced is stored.

An inventive method for decoding encoded image data into an image and controlling a frame memory in which the decoded image is stored includes: the step of releasing a frame in the frame memory in accordance with first information regarding control of the frame memory; the step of generating second information indicating the released frame; the step of decoding the encoded image data into the image; the step of storing the decoded image in the frame that the second information indicates; the step of determining, according to the encoded image data, which image among the images stored in the frame memory is not to be referenced in the decoding step; and the step of generating, as the first information, information regarding release of a frame in which the image that is not to be referenced is stored.

### BRIEF DESCRIPTION OF THE DRAWINGS

FIG. 1 illustrates the configuration of an image processing system according to a first embodiment of the present invention.

FIG. 2 is a view showing frame control information according to the first embodiment.

FIG. 3 is a view showing information on frame release.

FIG. 4 is a view indicating an operation algorithm performed by a storage location determination section according to the first embodiment.

FIG. 5 is a view illustrating the internal configuration of a determination section.

FIG. 6 is a view illustrating another form of the frame control information according to the first embodiment.

FIG. 7 illustrates the configuration of an image processing system according to a second embodiment of the present invention.

FIG. 8 is a view showing relationship between display time and display-processing-completed image.

FIG. 9 is a view showing frame control information according to the second embodiment.

FIG. 10 is a view indicating an operation algorithm performed by a storage location determination section according to the second embodiment.

### DETAILED DESCRIPTION OF THE INVENTION

Hereinafter, preferred embodiments of the present invention will be described with reference to the accompanying drawings.

### First Embodiment

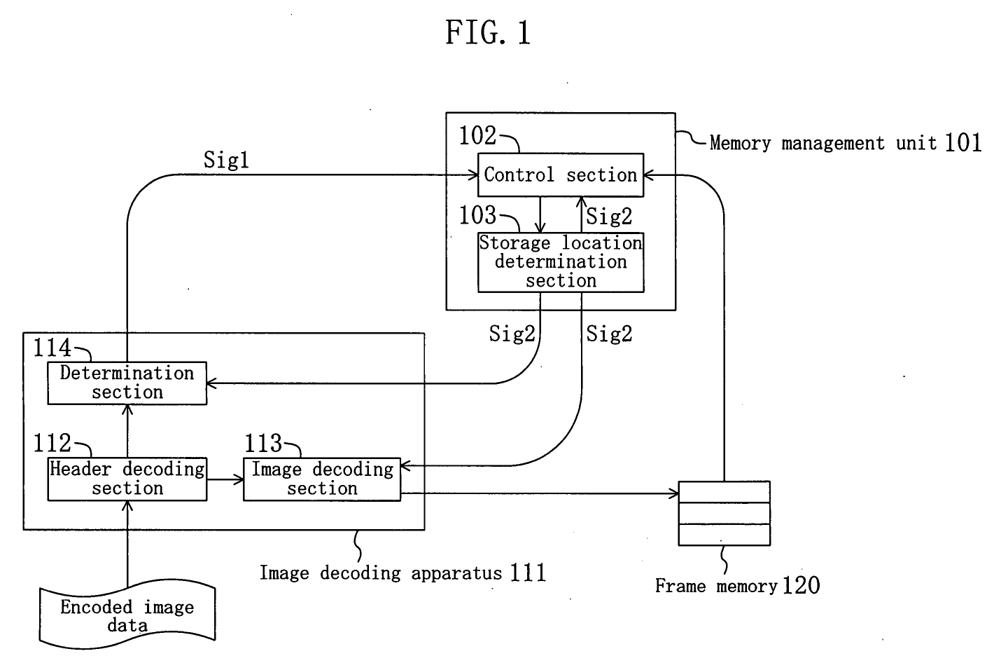

FIG. 1 illustrates the configuration of an image processing system according to a first embodiment of the present invention. The image processing system of this embodiment includes a memory management unit 101 and an image decoding apparatus 111. The memory management unit 101 controls a frame memory 120 that stores therein decoded images. The image decoding apparatus 111 decodes encoded image data and stores the decoded image in the frame memory 120. Specifically, the memory management unit 101 receives from the image decoding apparatus 111 information Sig1 on release of a frame, releases the frame according to this information, and outputs information Sig2 indicating the released frame. On the other hand, the image decoding apparatus 111 decodes data in encoded image data into an image and stores the obtained image in the frame that the information Sig2 indicates. The image decoding apparatus 111 then decodes data in the encoded image data into header information, and outputs, to the memory management unit 101, information Sig1 on release of a frame in which an image that will not be used as a reference picture is stored. The memory management unit 101 and then the image decoding apparatus 111 will be described below.

The memory management unit 101 includes a control section 102 and a storage location determination section 103.

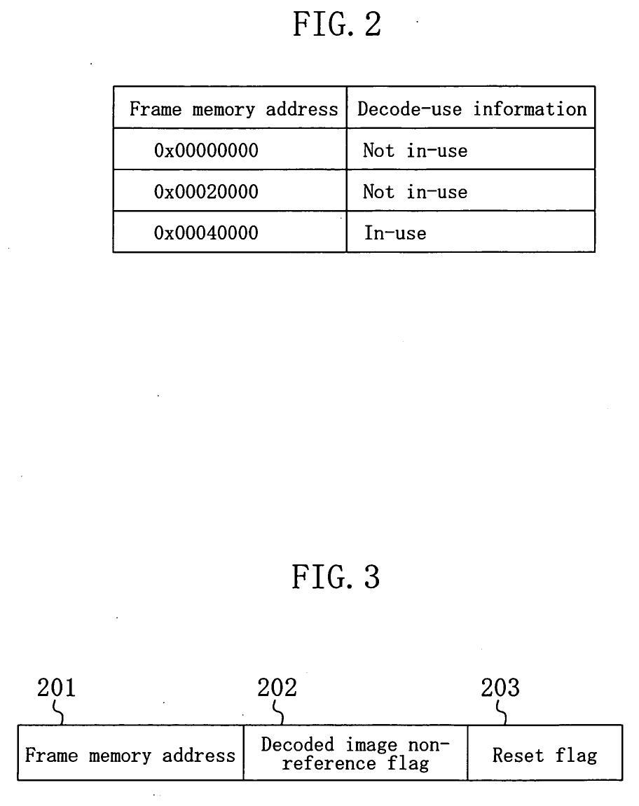

The control section 102 controls frame control information on the use status of each frame, in accordance with the information Sig1 and Sig2. FIG. 2 shows the frame control information. The frame control information contains frame memory addresses and decode-use information. The decode-use information indicates the use status of each frame. Specifically, the decode-use information indicates either “in use”, which corresponds to a first decoding state, or “not in use”, which corresponds to a second decoding state. If the decode-use information indicates that a frame is “in use”, it means that a picture that will be used as a reference picture is stored in the frame. On the other hand, if a frame is “not in use”, it means that the frame is released. To be more specific, no image is stored in that frame, or an image is stored in that frame, but the stored image will not be used as a reference picture.

FIG. 3 shows the configuration of the information Sig1. The information Sig1 contains a frame memory address 201, a decoded image non-reference flag 202, and a reset flag 203.

The frame memory address 201 indicates the address of a frame in which, among the images stored in the frame memory 120 except for the image newly decoded by the image decoding apparatus 111, an image that will not be needed as a reference picture in later decoding process is stored.

The decoded image non-reference flag 202 indicates whether or not the newly decoded image will be necessary as a reference picture. If the flag is set, it indicates that the image will not be necessary as a reference picture.

The reset flag 203 indicates whether or not all of the images stored in the frame memory 120 but the newly decoded image will be necessary as reference pictures. If the flag is set, it indicates that all of the images will be unnecessary.

Upon receipt of the information Sig1, the control section 102 sets the decode-use information for the frame indicated by the frame memory address 201, to “not in use”. If the decoded image non-reference flag 202 is set, the control section 102 sets the decode-use information for the frame in which the newly decoded frame is to be stored, to “not in use”. If the reset flag 203 is set, the control section 102 sets the decode-use information for all of the frames but the frame in which the newly decoded image is to be stored, to “not in use”.

The information Sig2 indicates the address of the frame in which the newly decoded image is to be stored. If the use status of the frame indicated by this address remains “not in use”, the stored image may be overwritten soon. Therefore, the control section 102 receives the information Sig2 and sets the decode-use information for the corresponding frame to “in use”.

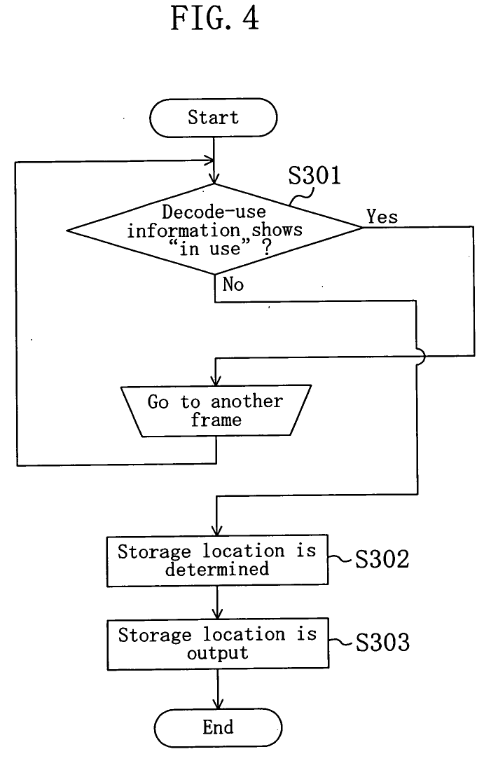

The storage location determination section 103 refers to the frame control information so as to detect a frame whose decode-use information exhibits “not in use”. Then, in order to allow the newly decoded image to be stored in this frame, the storage location determination section 103 outputs the address of this frame as the information Sig2 to the control section 102 and the image decoding apparatus 111. FIG. 4 indicates an operation algorithm performed by the storage location determination section 103. In Step S301, the storage location determination section 103 examines whether or not the decode-use information for a frame shows “in use”. Upon detection of a frame whose decode-use information indicates “not in use”, the storage location determination section 103 determines this frame as the storage location for the decoded image (Step S302) and outputs the address of this frame (Step S303).

When the frame control information is referenced for the frames, the reference may be performed either in ascending address order or in descending address order.

Referring back to FIG. 1, the image decoding apparatus 111 includes a header decoding section 112, an image decoding section 113, and a determination section 114.

The header decoding section 112 decodes data in encoded image data into header information. The header information varies depending on the moving picture coding method employed. In the case of MPEG-2 or MPEG-4 SP, the header information indicates the type of the encoded image contained in the encoded image data. On the other hand, in the case of MPEG-4 AVC, the header information contains information on a reference picture which is necessary to decode the encoded image contained in the encoded image data, and information indicating whether or not the image decoded from the encoded image data will be used as a reference picture.

The image decoding section 113 decodes data in the encoded image data into an image and stores the decoded image in the frame that the information Sig2 indicates.

Each time a decoded image is stored in the frame memory 120, the determination section 114 receives the information Sig2 to grasp what image is stored in which frame (this information will be hereinafter referred to as image location information). According to this image location information and the header information in the encoded image data, the determination section 114 determines which image, among the images stored in the frame memory 120, will not be used as a reference picture in decoding process. The determination section 114 then outputs information Sig1 regarding the release of the frame in which this image is stored.

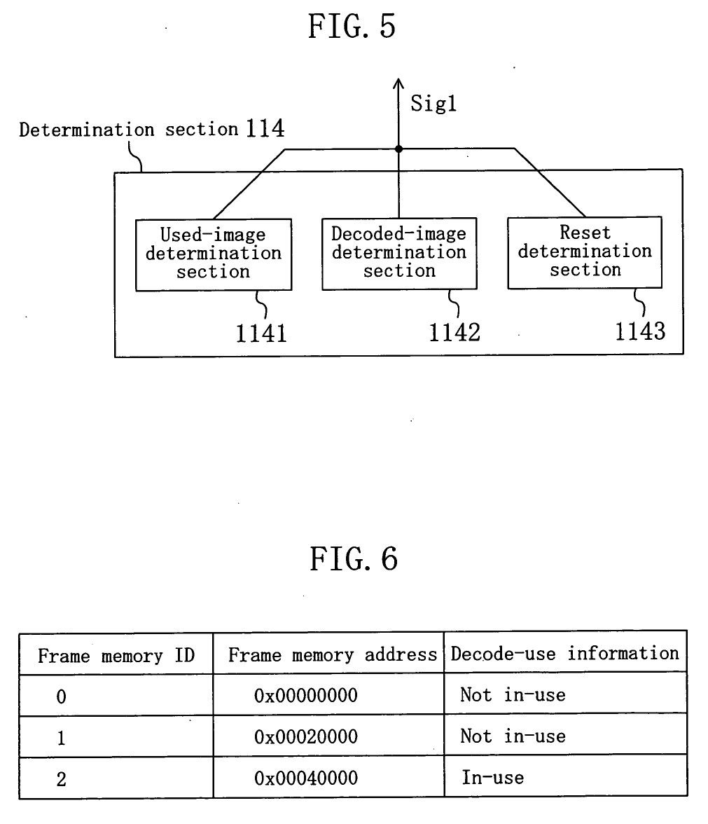

FIG. 5 illustrates the internal configuration of the determination section 114. The determination section 114 includes a used-image determination section 1141, a decoded image determination section 1142, and a reset determination section 1143.

According to the image location information and the header information in the encoded image data (which will be hereinafter referred to as encoded image data A) newly input into the image decoding apparatus 111, the used-image determination section 1141 determines which image, among all of the images that are stored in the frame memory 120 but the encoded image data A, will not be needed as a reference picture. The used-image determination section 1141 then outputs, as the frame memory address 201 shown in FIG. 3, the address of the frame in which this image is stored. For example, assume a case in which a P picture is decoded from encoded image data A produced according to MPEG-2. In this case, when the used-image determination section 1141 is notified of the header information for that P picture, the used-image determination section 1141 determines that a picture other than the I or P picture that was decoded immediately before that P picture will be unnecessary as a reference picture. The used-image determination section 1141 then outputs the address of the frame in which the unnecessary picture is stored.

The decoded image determination section 1142 determines whether or not the picture decoded from the encoded image data A will be necessary as a reference picture. If the decoded image is not necessary, the decoded image determination section 1142 sets the decoded image non-reference flag 202 shown in FIG. 3. For example, in a case in which a B picture is decoded from encoded image data A produced in accordance with MPEG-2, the B picture will not be used as a reference picture. Therefore, this flag is set.

The reset determination section 1143 determines whether or not all of the pictures stored in the frame memory 120 but the picture decoded from the encoded image data A will be needed as reference pictures. If all of the pictures are unnecessary, the reset determination section 1143 sets the reset flag 203 shown in FIG. 3. For example, in the case of MPEG-2, when an I picture is decoded from encoded image data A, the I picture does not need any reference pictures. Therefore, this flag is set.

As described above, the information Sig1 and the information Sig2 are both common information that can be used regardless of the type of moving picture coding method. This allows a common interface to be used between the memory management unit 101 and the image decoding apparatus 111.

As mentioned above, in this embodiment, it is possible to control the frame memory 120 by using a common method that can be used regardless of the type of moving picture coding method. This enables a common interface to be used between the memory management unit 101 and the image decoding apparatus 111. In addition, the configuration of the memory management unit 101 is simplified, permitting the circuit size to be reduced relatively. Furthermore, the amount of traffic between the memory management unit 101 and the image decoding apparatus 111 is reduced.

If the used-image determination section 1141 outputs, in several times, the addresses of frames, in which images that will not be needed as reference pictures are stored, the used-image determination section 1141 can function like the decoded image determination section 1142 and the reset determination section 1143. The determination section 1141 thus does not need to include the decoded image determination section 1142 and the reset determination section 1143. However, if the determination section 114 is provided with these sections, the determination section 114 can instruct release of a plurality of frames at a time by using a flag. Therefore, the amount of traffic required to output information on reference pictures is reduced as compared with a case in which the determination section 114 does not include these sections.

In some cases, the frame memory addresses of all frames may have the same lower bit values or the same upper bit values. For example, in FIG. 2, the lower 16 bits and the upper 8 bits of the frame memory are the same for all frames. In such a case, the portion having different frame memory addresses, that is, only the middle 8 bits, can be transmitted between the memory management unit 101 and the image decoding apparatus 111. The amount of traffic relating to the information Sig1 and Sig2 is thereby reduced.

FIG. 6 illustrates another form of frame control information. In the form shown in FIG. 6, frame memory IDs are added as part of the frame control information. The frame memory IDs are fixed and in a one-to-one correspondence with the addresses. In this case, the storage location determination section 103 and the used-image determination section 1141 may be designed so as to output a frame memory ID instead of a frame memory address. This also results in reduction in the amount of traffic relating to the information Sig1 and Sig2.

In the case of encoded image data produced in accordance with a moving picture coding method such as MPEG-2 or MPEG-4 SP, the rules of reference picture are determined by the type of image contained in the encoded image data. Therefore, the image decoding apparatus 111 may directly notify the image decoding section 113 and the determination section 114 of the type of image contained in the encoded image data, whereby the time required for the encoding of the header information in the encoded image data is saved.

Also, although the frame memory IDs are fixed in this embodiment, the frame memory IDs may be varied. For example, assume that the frame memory IDs indicate an image storage sequence established based on the first image stored in a frame after the input of encoded image data into the image decoding apparatus 111. In this case, if the determination section 114 is capable of storing decoded images and their positions in the storage sequence, it is possible for the determination section 114 to grasp what images are stored in the frames labeled with the frame memory IDs, that is, with the storage sequence. Therefore, in accordance with this information, the determination section 114 can output information Sig1 on frame release without receiving information Sig2.

### Second Embodiment

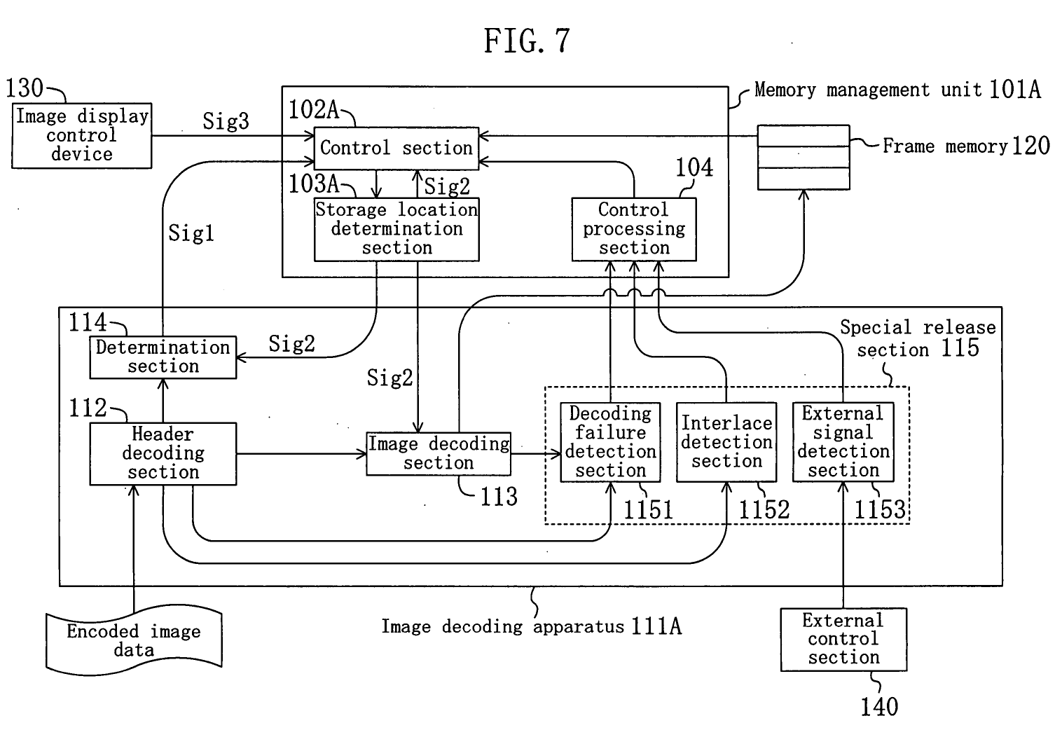

FIG. 7 illustrates the configuration of an image processing system according to a second embodiment of the present invention. The image processing system of this embodiment includes a memory management unit 101A and an image decoding apparatus 111A. The memory management unit 101A controls a frame memory 120. The image decoding apparatus 111A decodes encoded image data into an image and stores the decoded image in the frame memory 120. The memory management unit 101A includes a control section 102A, a storage location determination section 103A, and a control processing section 104. The image decoding apparatus 111A includes a header decoding section 112, an image decoding section 113, a determination section 114, and a special release section 115. An image display control device 130 is also provided inside or outside the image processing system of this embodiment. In this embodiment, since image processing is performed in substantially the same manner as described in the first embodiment, the image processing of this embodiment will be described only in terms of its difference from that of the first embodiment.

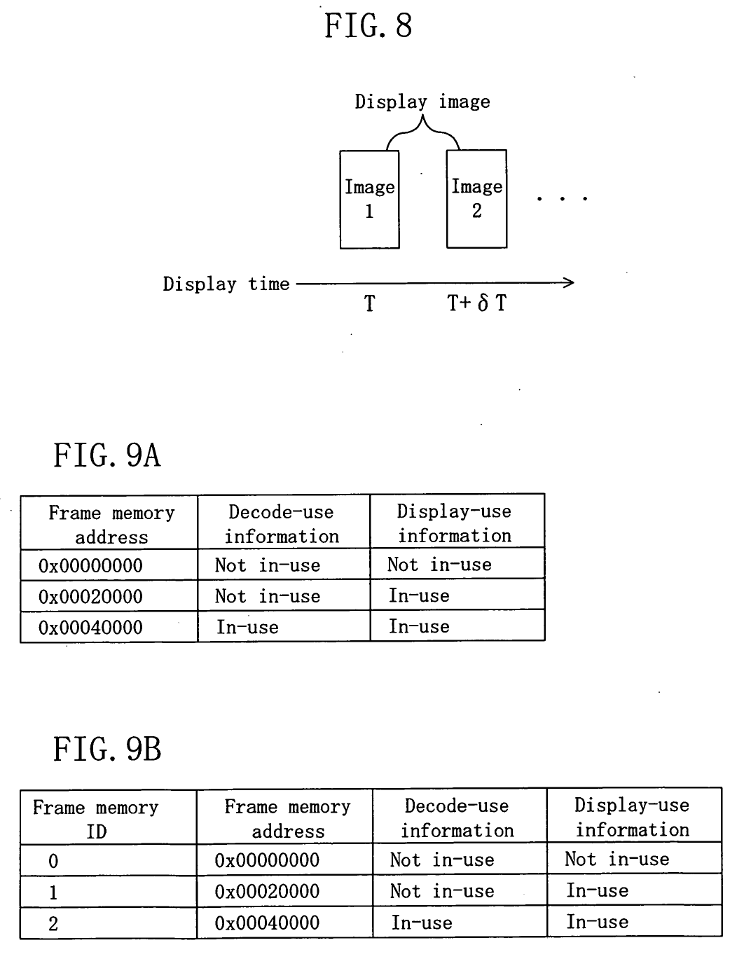

The image display control device 130 outputs the address of a frame as information Sig3 to the control section 102A. In this frame, a displayed image, or an image that was used to display another image and then became unnecessary (which will be hereinafter referred to as a “display-processing-completed image”) is stored. FIG. 8 shows relationship between display time and display-processing-completed image. The display image at time T is an image 1. At the next time T+δT, an image 2 is displayed. At this time, the image 1 already displayed at the time T is a display-processing-completed image. When the image 1 has become a display-processing-completed image, the image display control device 130 notifies the control section 102A of the address of the frame in which the image 1 is stored. Another display method is time-based filtering, in which the images existing immediately before and after an image 1 in display time order are used to display the image 1. In this method, an already displayed image or an image that will not be used in the filtering process corresponds to a display-processing-completed image.

The control section 102A controls frame control information regarding the use status of each frame, in accordance with information Sig1, Sig2, and Sig3. FIG. 9 shows the frame control information controlled by the control section 102A. Like the decode-use information, display-use information shown in FIG. 9A indicates the use status of the frame memory 120. Specifically, the display-use information indicates either “in use”, which corresponds to a first display state, or “not in use”, which corresponds to a second display state. If the display-use information indicates that a frame is “in use”, it means that an image that will be used in display processing is stored in the frame. On the other hand, if a frame is “not in use”, it means that no image is stored in that frame, or that an image is stored in that frame, but the stored image will be unnecessary in display processing. Upon receipt of information Sig3, the control section 102A sets the display-use information for the frame having the address indicated by the information Sig3 to “not in use”. When the control section 102A receives information Sig2, the control section 102A sets the decode-use information and the display-use information for the corresponding frame to “in use”.

The information Sig3 may indicate only part of the corresponding address, so long as the frame of that address can be identified. The amount of traffic relating to the information Sig3 is thereby reduced.

As shown in FIG. 9B, frame memory IDs, which are in a one-to-one correspondence with the addresses, may be added as part of the frame control information. In this case, the image display control device 130 may transmit a memory ID instead of an address, which also leads to reduction in the amount of traffic relating to the information Sig3.

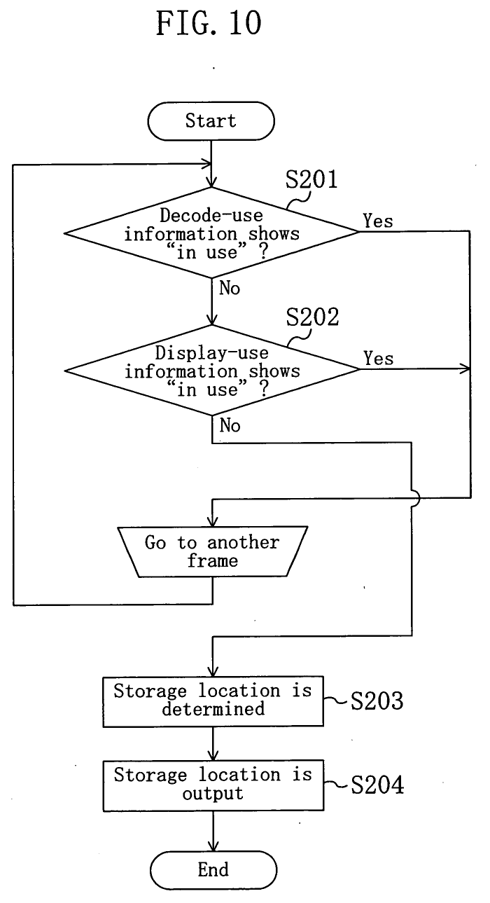

The storage location determination section 103A refers to the decode-use information and the display-use information to output the address of a released frame. FIG. 10 indicates an operation algorithm performed by the storage location determination section 103A. In Step S201, the storage location determination section 103A examines whether or not the decode-use information for a frame shows “in use”. In Step S202, the storage location determination section 103A examines whether or not the display-use information for that frame shows “in use”. Upon detection of a frame whose decode-use information and display-use information both indicate “not in use”, the storage location determination section 103A determines this frame as the storage location for the decoded image (Step S203) and outputs the address of this frame (Step S204).

Independently of the determination section 114, the special release section 115 outputs a control signal relating to frame-memory release. The special release section 115 is provided with a decoding failure detection section 1151, an interlace detection section 1152, and an external signal detection section 1153.

When a decoding failure occurs in the process of decoding header information or in the process of decoding an image, the decoding failure detection section 1151 receives a decoding failure signal from the header decoding section 112 or from the image decoding section 113. The decoding failure detection section 1151 then transmits to the control processing section 104 a control signal for setting the decode-use information and the display-use information for the frame in which the image having the header information with the decoding failure or the image with the decoding failure is stored, to “not in use”.

When a decoded image is subjected to interlacing process, the interlace detection section 1152 receives an interlace signal output from the header decoding section 112 and transmits to the control processing section 104 a control signal for controlling two frames for the one image.

The external signal detection section 1153 receives an external process signal from an external control section 140 and transmits to the control processing section 104 a control signal which corresponds to the contents of the external process signal. Examples of the external process include a skipping process in which only I pictures are played back, and flash process for initializing the frame memory 120. Upon receipt of a skipping-process signal, the external signal detection section 1153 sends to the control processing section 104 a control signal for setting the decode-use information for the frames, in which decoded I pictures are to be stored, to “not in use”, because the I pictures will not be used as reference pictures during the skipping process. When the external signal detection section 1153 receives a flash process signal, the external signal detection section 1153 sends to the control processing section 104 a control signal for setting the decode-use information and the display-use information for all frames to “not in use”, so that the frame memory 120 is initialized, that is, so that the frame memory 120 stores no images therein.

The control processing section 104 gives priority to the frame control information setting based on the control signals over the frame control information setting according to the information Sig1, Sig2, and Sig3.

As described above, in this embodiment, it is possible to control the frame memory 120 with the condition of image display processing being grasped. In addition, when a decoding failure occurs, when an image has to be subjected to interlacing processing, or when an external process signal is received, the processing required is preferentially controlled in an optimal manner.

Although the special release section 115 includes the decoding failure detection section 1151, the interlace detection section 1152, and the external signal detection section 1153 in this embodiment, the special release section 115 may include other sections for performing other special processing. The special release section does not always have to be provided, but may be provided when necessary.

What is claimed is:

1. A memory management unit for controlling a frame memory for storing therein images decoded by an image decoding apparatus, the memory management unit comprising:
a control section for receiving, from outside, first information on release of a frame in which an image that is not to be referenced in image decoding processing performed by the image decoding apparatus is stored, and releasing the frame in accordance with the first information; and
a storage location determination section for outputting, to outside, second information indicating the released frame.

2. The memory management unit of claim 1, wherein the control section determines for each of frames in the frame memory whether the frame is in a first decoding state or a second decoding state, and sets the frame indicated by the first information to the second decoding state, the first decoding state being a state in which an image that is to be referenced in the decoding processing is stored, the second decoding state being a state other than the first decoding state; and
the storage location determination section outputs, as the second information, information indicating one of frames that are in the second decoding state.

3. The memory management unit of claim 2, wherein the control section determines for each of the frames in the frame memory whether the frame is in a first display state or a second display state, receives, from outside, third information on release of a frame in which an image that is to be unnecessary for display is stored, and sets the frame indicated by the third information to the second display state, the first display state being a state in which an image that is to be necessary for display is stored, the second display state being a state other than the first display state; and
the storage location determination section outputs, as the second information, information indicating one of frames that are in the second decoding state and in the second display state.

4. The memory management unit of claim 2, further comprising a control processing section for receiving a control signal from outside and setting a frame relating to the control signal to the second decoding state.

5. An image decoding apparatus comprising:
an image decoding section for decoding encoded image data into an image and storing the image in a frame indicated from outside; and
a determination section for determining, according to the encoded image data, which image, among an image to be stored in the frame and images stored in a frame memory, is not to be referenced in decoding process performed by the image decoding section, and outputting, to outside, first information on release of a frame in which the image that is not to be referenced is stored.

6. The image decoding apparatus of claim 5, wherein the determination section includes a used-image determination section for determining which image among the images stored in the frame memory is not to be referenced in the decoding process performed by the image decoding section, and outputting, as the first information, information indicating a frame in which the image is stored.

7. The image decoding apparatus of claim 5, wherein the determination section includes a decoded image determination section for determining whether or not the image to be stored in the frame is to be referenced in the decoding process performed by the image decoding section, and outputting information indicating a determination result as the first information.

8. The image decoding apparatus of claim 5, wherein the determination section includes a reset determination section for determining for each of the images stored in the frame memory whether or not the image is to be referenced in the decoding process performed by the image decoding section, and outputting information indicating a determination result as the first information.

9. The image decoding apparatus of claim 5, further comprising a special release section for outputting, to outside, a control signal relating to release of a given frame in the frame memory.

10. The image decoding apparatus of claim 9, wherein the special release section includes a decoding failure detection section which, upon the occurrence of a failure in the decoding process performed by the image decoding section, outputs as the control signal a signal relating to release of a frame in which an image that was not properly decoded is to be stored.

11. The image decoding apparatus of claim 9, wherein the special release section includes an interlace detection section which, when an image decoded by the image decoding section is an interlaced image, outputs as the control signal a signal relating to release of a frame that is necessary for interlaced image processing.

12. The image decoding apparatus of claim 9, wherein the special release section includes an external signal detection section for receiving a signal from outside and outputting, as the control signal, a signal relating to release of a frame indicated by the signal.

13. An image processing system including an image decoding apparatus for decoding encoded image data into an image, and a memory management unit for controlling a frame memory in which the decoded image is stored,
wherein the memory management unit includes:
a control section for receiving first information on control of the frame memory and releasing a frame in the frame memory in accordance with the first information, and
a storage location determination section for outputting second information indicating the released frame; and
the image decoding apparatus includes:
an image decoding section for decoding the encoded image data into the image and storing the decoded image in the frame that the second information indicates, and
a determination section for determining, according to the encoded image data, which image among the images stored in the frame memory is not to be referenced in decoding process performed by the image decoding section, and outputting, as the first information, information on release of a frame in which the image that is not to be referenced is stored.

14. A method for decoding encoded image data into an image and controlling a frame memory in which the decoded image is stored, the method comprising:
the step of releasing a frame in the frame memory in accordance with first information regarding control of the frame memory;
the step of generating second information indicating the released frame;
the step of decoding the encoded image data into the image;
the step of storing the decoded image in the frame that the second information indicates;
the step of determining, according to the encoded image data, which image among the images stored in the frame memory is not to be referenced in the decoding step; and
the step of generating, as the first information, information regarding release of a frame in which the image that is not to be referenced is stored.
